(19) United States
(12) Patent Application Publication
(10) Pub. No.: US 2002/0069566 A1
(43) Pub. Date: Jun. 13, 2002

(54) Modular wall for installation thereon of outdoor display and advertisement

(76) Inventor: Avner Netter, Tel-Aviv (IL)

Correspondence Address: BROWDY AND NEIMARK, P.L.L.C., 419 Seventh Street, N.W., Washington, DC, 20004, US

(21) Appl. No.: 09/813,800

(22) Filed: Mar. 22, 2001

(30) Foreign Application Priority Data
Jul. 25, 2000 (IL) 137499

(51) Int. Cl. G09F 15/00

(52) U.S. Cl. 40/606; 40/624

(57) ABSTRACT

A modular supporting structure for advertising billboards and/or displays in outdoor locations assembled from a plurality of prefabricated hollow blocks arranged in stacked tiers, preferably from used cargo ship containers. The structure is sufficiently high for a billboard to be viewed from a large distance, and is capable of staying in place by virtue of its own weight, by ballasting, or by means of simple anchoring elements.

### FIELD OF THE INVENTION

This invention relates to billboard or advertisement structures, and more specifically to billboards suitable for outdoor locations.

### BACKGROUND OF THE INVENTION

Modern industry and modern business rely heavily on advertising. Logos, brand names, signs and posters of international and local companies, products and services have become a trivial part of modern landscape, both downtown, in the suburbs, and even in the country.

One of the trends in modern advertising is to place huge images on outdoor billboards occupying prominent positions in a town's topography, on building facades and roofs, or along highways, roads and streets in open areas. Large-size billboards and structures supporting them often require complex and expensive engineering and construction works. Such structures must meet rigid strength, reliability, environmental and safety standards while withstanding elemental forces as wind, rain, temperature variations and solar radiation.

Particularly referring to billboards disposed along highways, roads and streets, it is desirable to increase their size in order to make the images thereon readable from a fast-moving vehicle, for a longer time, and from a larger distance. Building of a conventional large stand-alone billboard structure involves erecting of deeply anchored and strong pillars, earth-moving and concrete works. Such a structure is most often expensive and very difficult to dispose of, should the terrain be cleaned for another use.

### SUMMARY OF THE INVENTION

A modular supporting structure for advertising billboards or displays in outdoor locations, comprising a plurality of large hollow prefabricated blocks arranged in at least two stacked tiers, the structure being capable of staying in place essentially by virtue of its own weight.

Preferably, the width of said prefabricated blocks is larger than about half-height thereof and the overall width of said structure is greater than about half the overall height thereof.

Advantageously, the prefabricated blocks are standard ship containers available in ports and container terminals. The supporting structures of the present invention allow fast assembly and disassembly of billboards of large height and unlimited length, in flexible configurations, and with minimal or no preparatory ground works.

### BRIEF DESCRIPTION OF THE DRAWINGS

In order to understand the invention and to see how it may be carried out in practice, preferred embodiments will now be described, by way of non-limiting example only, with reference to the accompanying drawings, in which:

FIG. 1 is a prospective view of a modular billboard structure in ‘Wall’ configuration according to the present invention;

FIG. 2 is a prospective view of a modular billboard structure in ‘Gates’ configuration according to the present invention;

FIG. 3 is a prospective view of a modular billboard structure in ‘Corner’ configuration according to the present invention; and

FIG. 4 is a prospective view of a modular billboard structure in ‘Fence’ configuration according to the present invention.

### DETAILED DESCRIPTION OF PREFERRED EMBODIMENTS

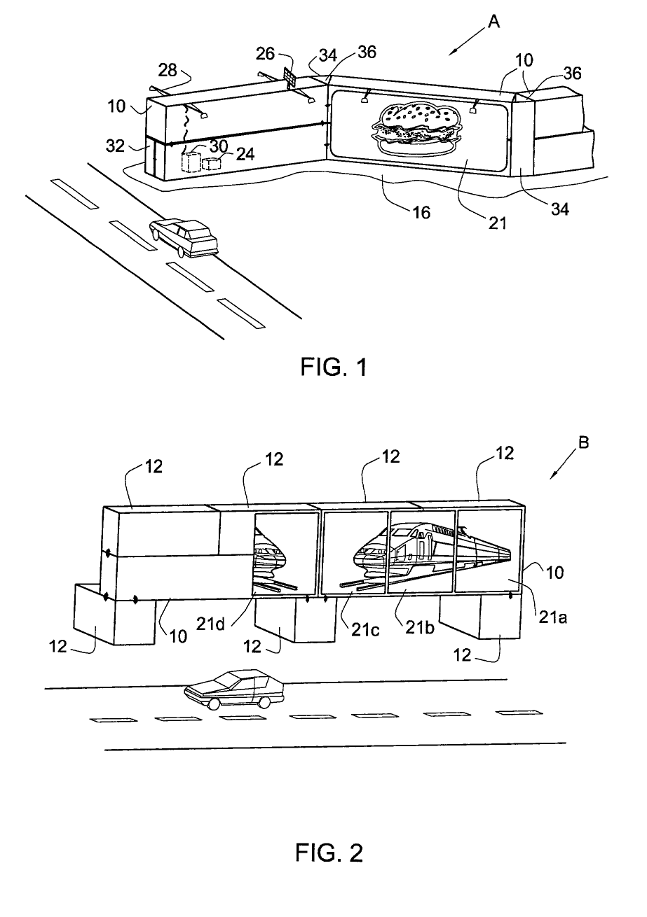

FIGS. 1 to 4 illustrate billboard structures A, B, C and D according to the present invention, that are assembled in various configurations from prefabricated modules or blocks 10 and 12, like in a toy construction set. The billboard site 16, that may be located anywhere but is preferably located alongside a highway in an open country terrain, may be prepared only by leveling and may be covered by a thin concrete layer or bituminous coating.

The prefabricated blocks may have different sizes (only two kinds being shown in FIGS. 1 to 4) and may be transported to the site 16 by trailers and installed in place by a motorized crane. In the billboard structures, adjacent and stacked blocks may be not connected to each other or may be secured by suitable connections 18.

As shown in FIG. 2, the billboard 21, which is to be mounted on the structure's facade, may be divided into panels 21a, 21b, 21c, 21d and fitted to each block before assembly of the billboard structure, or may be mounted on the assembled structure. The billboard structure may be equipped with autonomous sources of energy such as a diesel-generator 24 or solar panel with battery 26, lights 28, control and communication devices 30, etc.

The blocks 10 and 12 are characterized by their dimensions H×W×L (height, width, length), weight P, and loading capacity or strength S. The blocks may be combined in length, and stacked in tiers in height in order to produce the necessary display area for the billboard. The modular design provides for easy restructuring of the arrangement into a wide range of overall dimensions. Transverse stability can be achieved by erecting two or more stacks side by side, or by arranging some or all of the blocks transversely to the facade of the structure (e.g. structures B and D), thus increasing the width of the structure.

In order to allow a simple way of assembly and disassembly, the structure should be able to retain stability under the action of external forces, especially under forces exerted by the wind, largely due to its weight and configuration, preferably without anchorage, with connections 18 playing only auxiliary role if needed. For this purpose, the width of a block should be at least about half its height and the width of the whole structure should also be at least about half the height of the structure. A block has to be strong enough to carry the weight of the billboard as well as of several blocks stacked above it, and be heavy enough to withstand forces exerted by the wind. Yet a block has to be not too heavy as to hinder the transportation and assembly but may be ballasted at the assembly site.

The above requirements present a wide choice of construction blocks, both specifically produced for billboard construction or for a different original purpose. It has been found especially advantageous to make use of standard ship containers. They are available in ports and container terminals in large quantities at bargain prices. The following table shows design characteristics of standard 20′ and 40′ containers:

| | Overall dimensions | | | Payload | Tare |
|---|---|---|---|---|---|
| Container type | L, m | W, m | H, m | S, Kg | P, Kg |
| 20′ | 6.058 | 2.438 | 2.591 | 21-30,000 | 2000-3400 |
| 40′ | 12.192 | 2.438 | 2.591 | 26-40,000 | 3600-6050 |
| 40′ High Cube | 12.192 | 2.438 | 2.900 | 26,000 | 4200 |

Ship containers are designed to carry the weight of 3-4 tiers or more of loaded containers plus dynamic loading due to a carrier ship motions in waves. This means that empty containers will have enough strength to allow stacking in 3-4 or even more tiers, to bear their own and the billboard's weight and to withstand forces exerted by the wind.

Ship containers have also such other advantages as:

built-in elements for securing containers to each other;

internal space accessible through the existing doors 32 which may be used for accommodation of various auxiliary devices such as mentioned above, or for ballasting;

the possibility of being scrapped and recycled when worn out beyond further use.

FIGS. 1 to 4 illustrate examples of a few basic configurations of billboard supporting structures built of 20′ and 40′ ship containers:

‘Wall’ structure A (FIG. 1) essentially unlimited in length, may be straight or in zig-zag shape with special billboard elements 34 covering the V-gaps 36;

‘Gates’ structure B (FIG. 2) with 40′ containers 10 bridging gaps between each two 20′ containers 12, wherein the structure is less heavy but might need stronger connections either like connections 18 or of other appropriate design, and may be measures to ensure the strength of containers 10;

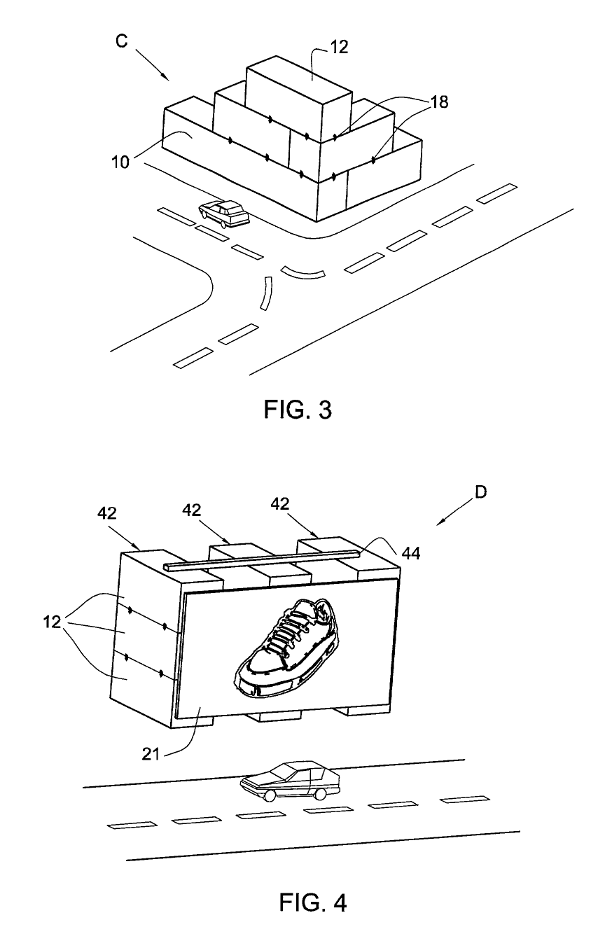

‘Corner’ structure C (FIG. 3) with overlapping 40′ and 20′ containers, suitable for sites at crossroads;

‘Fence’ structure D (FIG. 4) with suitably spaced ‘pillars’ 42 assembled of a few containers each, wherein the billboard 21 may be mounted to extend between the ‘pillars’, while the whole structure may be reinforced by a common beam 44.

If it is desirable to erect a supporting structure including 3 and more tiers of containers, additional stabilizing means may be used, such as strengthening elements connecting adjacent or remote containers, anchors to fix bottom tier containers to the terrain, and struts or braces connecting upper tier containers to the terrain.

It is obvious that numerous other arrangements and variations of modular billboard structures, and different shapes and dimensions of the blocks are possible without departing from the spirit and the scope of the present invention.

1. A modular supporting structure for advertising billboards and/or displays in outdoor locations, wherein said structure is assembled from a plurality of prefabricated hollow blocks arranged in at least two stacked tiers on a leveled terrain, said structure being sufficiently high for a billboard to be viewed from a large distance, and being capable of staying in place essentially by virtue of its own weight.

2. A supporting structure according to claim 1, wherein at least one of said prefabricated hollow blocks is at least partially filled with ballast.

3. A supporting structure according to claim 1, wherein the width of said prefabricated hollow blocks is larger than about half-height thereof.

4. A supporting structure according to claim 1, wherein the overall width of said structure is greater than about half the overall height thereof.

5. A supporting structure according to claim 1, wherein said prefabricated hollow blocks are cargo containers.

6. A supporting structure according to claim 5, wherein said cargo containers are standard ship containers.

7. A supporting structure according to claim 6, wherein its upper horizontal surface is used as a display platform.

8. A supporting structure according to claim 5, wherein the structure is additionally stabilized by at least one of the following:
connecting elements between adjacent containers;
anchoring elements connecting lower tier containers to the terrain;
struts or braces connecting upper tier containers to the terrain.
